(19) United States
(12) Patent Application Publication
(10) Pub. No.: US 2002/0152595 A1
(43) Pub. Date: Oct. 24, 2002

(54) Process for producing supporting frameworks for electrodes of galvanic elements

(76) Inventors: Gerolf Richter, Hildesheim (DE); Karlo Popp, Ronnenberg (DE)

Correspondence Address: SCHNADER HARRISON SEGAL & LEWIS, LLP, 1600 MARKET STREET, SUITE 3600, PHILADELPHIA, PA, 19103

(21) Appl. No.: 10/106,577

(22) Filed: Mar. 26, 2002

(30) Foreign Application Priority Data
Apr. 23, 2001 (DE) 101 19 841.8

(51) Int. Cl. B21D 31/04; B23P 17/00

(52) U.S. Cl. 29/6.1; 29/412

(57) ABSTRACT

A process for producing supporting frameworks for electrodes of galvanic elements, in the form of plates which include expanded metal, including providing a metal strip with incisions in the conveying direction, expanding the metal strip substantially transversely to the incisions, pressing/flattening the expanded metal in a region of the strip selected for cuts to be made transversely to the conveying direction, and dividing the strip by cutting in the region.

### FIELD OF THE INVENTION

This invention relates to a process for producing supporting frameworks for electrodes of galvanic elements, in the form of plates which consist of expanded metal, in which process a metal strip is provided with incisions in the conveying direction and is expanded substantially transversely to these incisions and is divided by cuts made transversely to the conveying direction. This invention also relates to processes for producing electrodes having supporting frameworks of this type and to the supporting frameworks and electrode plates which are produced using processes of this type.

### BACKGROUND

The majority of galvanic elements have positive and negative electrodes separated by separators, the electrodes having conductive supporting frameworks provided with the actual active compounds.

The supporting framework is often expanded-metal material. To produce this material, by way of example, a metal strip is conveyed between blade rollers and provided with incisions in the conveying direction. Then, the cut strip is expanded transversely to the conveying direction. In general, there is a mesh-free part at least at one longitudinal edge, which is used to electrically connect the expanded-metal framework to discharge poles or from which, if appropriate, connection lugs are stamped. Individual plates are formed from the expanded-metal strip by cuts made transversely to the conveying direction, and these plates are then pasted and, as finished electrodes, are assembled to form electrode blocks or wound electrodes, or, alternatively, the expanded-metal strip is pasted and then cut into plates of the desired size.

Thin separators are arranged between positive and negative electrodes of galvanic elements of this type. The separating cut made during production of plates from the expanded-metal strip results in formation of sharp-edged exposed edges with metal points which can puncture the separator material and, therefore, lead to a short circuit in the galvanic element.

To prevent such puncturing of the separator material, special separator designs which are thickened in the region of the plate edges are used. Separators of this type are known, for example, from EP 484295 B1 or EP 899801 A1. EP 899801 A1 also shows a typical illustration of standard expanded-metal frameworks.

However, it has been found that measures of this type are insufficient to reliably prevent punctures.

Therefore, it would be highly advantageous to provide a process for producing expanded-metal supporting frameworks or electrodes having an expanded-metal supporting framework, which provides supporting frameworks and electrodes in which puncturing of the separator material at the electrode edges is reliably avoided.

### SUMMARY OF THE INVENTION

This invention relates to a process for producing supporting frameworks for electrodes of galvanic elements, in the form of plates which comprise expanded metal, including providing a metal strip with incisions in the conveying direction, expanding the metal strip substantially transversely to the incisions, pressing/flattening the expanded metal in a region of the strip selected for cuts to be made transversely to the conveying direction, and dividing the strip by cutting in the region.

This invention also relates to a supporting framework for electrode plates of galvanic elements, which comprise expanded metal, including providing a metal strip with incisions in the conveying direction, expanding the metal strip substantially transversely to the incisions, pressing/flattening the expanded metal in a region of the strip selected for cuts to be made transversely to the conveying direction, and dividing the strip by cutting in the region.

This invention further relates to a process for producing electrodes for galvanic elements having a supporting framework made from expanded metal, including providing a metal strip with incisions in the conveying direction, expanding the metal strip substantially transversely to the incisions, pasting active compound into the expanded-metal strip, pressing/flattening the metal strip in a region of the cuts before or after pasting the active compound, and dividing the metal strip by cutting made transversely to the conveying direction.

This invention still further relates to an electrode plate for galvanic elements, having a supporting framework made from expanded metal, including providing a metal strip with incisions in the conveying direction, expanding the metal strip substantially transversely to the incisions, pasting active compound into the expanded-metal strip, pressing/flattening the metal strip in a region of the cuts before or after pasting the active compound, and dividing the metal strip by cutting made transversely to the conveying direction.

### BRIEF DESCRIPTION OF THE DRAWINGS

The subject matter of the invention is explained below with reference to FIGS. 1 to 3.

FIG. 1 shows a front elevational view of a part of an expanded-metal strip; and

FIGS. 2 and 3 are cross-sectional views taken through a strip of the type shown in FIG. 1.

### DETAILED DESCRIPTION

According to the invention, the expanded-metal strip is pressed flat in the intended region of the cuts before it is divided into individual plates and then cut or trimmed to length in the region that has been pressed flat. This region may be pressed flat before the expanded-metal strip has been treated further or after the active compound has been pasted into the expanded-metal strip. It is particularly advantageous for the expanded-metal strip to be compressed to such an extent in this region, which subsequently forms the lateral edge of the plate, that the original material thickness of the strip material is reached. It is particularly advantageous when using expanded lead, as is used for lead storage batteries, to deform the material and, for example, to press it so flat that a thickness of approximately 10 to 20% of the original material thickness or web thickness is achieved.

If, during the pasting operation, the electrode has been covered with a protective paper on both sides, it is particularly advantageous, after the region of the cut has been pressed flat, for the protective paper present in this region and a small region to the side of this cut region to be treated with a material which leads to additional strengthening in the cut edge region of the electrode. For this purpose, by way of example, it is possible for a plastic which is dissolved in a solvent, a synthetic resin or an inorganic coating to be sprayed onto this region. A procedure of this type increases the protection of the plate edge against bending considerably. Materials that are suitable for impregnating the pasting paper in strip form are plastics, such as polyester, styrene, polyisocyanate, polyacrylates, silicone rubber or nitrocellulose coating materials. It is also possible to use water glass or rosin which is dissolved in, for example, toluene to be used. If appropriate, drying can be accelerated by heating, UV radiation or the like.

The starting point for production of an electrode which is suitable for lead storage batteries is, for example, a lead strip which is approximately 1 mm thick. This strip is partially provided, in the conveying direction, with parallel, offset cuts, with a region which is not slotted remaining on at least one side for subsequent electrical connection to other electrodes. Then, the slotted strip is expanded transversely to the conveying direction, the diamond-shaped grid which is formed is pasted with the active material of the negative or positive plate and immediately afterwards is covered on both sides with a protective sheet, generally a paper which subsequently dissolves in the battery acid. The strip is then processed into relatively long pieces, if appropriate for production of a coil, together with a separator and an electrode with the opposite polarity. It may also be cut into short individual electrodes, such as those used in prism-shaped storage battery cells.

To avoid the occurrence of protruding grid ends at the cut edges of the plates, forming the lateral edges of the plates formed, and to prevent points on the edge webs from being able to be bent out of the plane of the plate, the expanded-metal grid rods, which have a typical cross-sectional area of approximately 1 mm², are pressed flat to a thickness of approximately 0.1 mm. A grid web point which has been deformed and is particularly soft in the edge or cut region can no longer puncture a standard separator, which has a thickness of 0.1 to 0.2 mm. Even by the small guiding forces acting on both sides, it is prevented from being permanently bent out of the plane of the plate.

To produce flattened grid webs of this type along the plate cut edge, it is appropriate to use a blade structure which initially, in a very tightly restricted part of the cut zone, greatly compresses the expanded-metal grid over the entire strip width or electrode height and then cuts through it precisely in the centre. To avoid alignment problems, the compression devices or compressed edges, together with the cutting blade, are mounted on a common shaft so that the spacing thereof over the circumference of a roller precisely corresponds to the length of the plate which is to be cut.

During the pressing-flattening operation, a pressing amounting to approximately 10 to 20% of the original strip thickness, i.e., in the case of electrodes which are produced from 1 mm thick lead strip, to approximately 0.1 mm, has proven sufficient. This pressing-flattening takes place in a range which is approximately 2 to 3 mm from the cut edge on both sides.

It is particularly advantageous for the protective paper sheet which is applied after the active compound has been introduced to be consolidated with a plastics material within which is subsequently the cut zone and approximately 3 to 4 mm on both sides of what subsequently forms the cut edge. It is then possible, for example, to spray a heat curing plastic onto this region, or to use synthetic resins or water-containing organic coating materials which, after the protective paper sheet has dried, impart a strength to this region which is such that the flattened grid rods below it are provided with additional protection against bending.

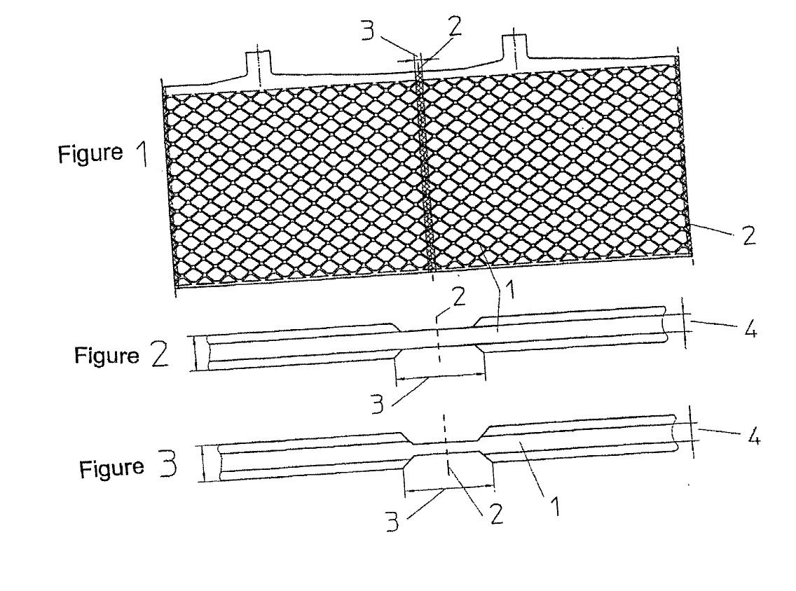

Turning now to the drawings generally, and FIG. 1 in particular, the expaned-metal strip 1 is pressed flat in the region of the cut edge 2. The region 3 which has been pressed flat extends approximately 2 to 3 mm on both sides of the cutting point 2. As shown in FIG. 2, the expanded-metal strip 1 has been pressed flat to the thickness of the lead strip 4, while according to FIG. 3, the lead strip has been deformed even beyond the thickness.

Electrode plates with plate edges which have been treated in accordance with the invention can pass through all the subsequent manufacturing processes without problems and without there being any risk of a thin film separator being punctured.

We claim:

1. A process for producing supporting frameworks for electrodes of galvanic elements, in the form of plates which include expanded metal, comprising:
providing a metal strip with incisions in a conveying direction;
expanding the metal strip substantially transversely to the incisions;
pressing/flattening the expanded metal in a region of the strip selected for cuts to be made transversely to the conveying direction; and
dividing the strip by cutting in the region.

2. The process as claimed in claim 1, wherein the expanded-metal strip is compressed to the thickness of the metal strip.

3. The process as claimed in claim 1, wherein the expanded-metal strip is compressed to about 10- about 20% of the original thickness of the metal strip.

4. A process for producing electrodes for galvanic elements having a supporting framework made from expanded metal, comprising:
providing a metal strip with incisions in a conveying direction;
expanding the metal strip substantially transversely to the incisions;
pasting active compound into the expanded-metal strip;
pressing/flattening the metal strip in a region of the cuts before or after pasting the active compound; and
dividing the metal strip by cutting made transversely to the conveying direction.

5. The process as claimed in claim 4, wherein the expanded-metal strip is compressed to the thickness of the metal strip.

6. The process as claimed in claim 4, wherein the expanded-metal strip is compressed to about 10 to about 20% of the original thickness of the metal strip.

7. The process as claimed in claims 4, wherein the pasted strip is covered with protective paper, and the protective paper is consolidated in the region which has been pressed flat by means of a plastic material which is applied to this region.

8. A supporting framework for electrodes of galvanic elements, produced according to claim 1.

9. The supporting framework as claimed in claim 8, which comprises a lead alloy.

10. A supporting framework for electrodes of galvanic elements, produced according to claim 4.

11. The supporting framework as claimed in claim 10, which comprises a lead alloy.

12. An electrode produced according to claim 4.

13. The electrode as claimed in claim 12, wherein the supporting framework comprises a lead alloy.
